(19) United States
(12) Patent Application Publication
(10) Pub. No.: US 2012/0235992 A1
(43) Pub. Date: Sep. 20, 2012

(54) STEREOSCOPIC IMAGE PROCESSING APPARATUS AND STEREOSCOPIC IMAGE PROCESSING METHOD

(76) Inventors: Kenjiro TSUDA, Kyoto (JP); Yoshiyuki OKIMOTO, Nara (JP); Takayoshi KOYAMA, Osaka (JP)

(21) Appl. No.: 13/419,735

(22) Filed: Mar. 14, 2012

(30) Foreign Application Priority Data
Mar. 14, 2011 (JP) 2011-055106
Mar. 13, 2012 (JP) 2012-056114

(51) Int. Cl. G06T 15/00

(52) U.S. Cl. 345/419

(57) ABSTRACT

A stereoscopic image processing apparatus includes an input/output interface operable to obtain a stereoscopic image including images at least at two view points, a parallax information detector operable to obtain parallax information about a parallax value for at least one of an upper region including an upper end and a lower region including a lower end of the obtained stereoscopic image, a display method setting unit operable to set a display method of an image on the region for which the parallax information is obtained, based on the parallax information about the region, an signal processor operable to process the image of the stereoscopic image on the region for which the parallax information is obtained, based on the set display method, and an signal processor operable to output a new stereoscopic image obtained based on the processed result.

### BACKGROUND

1. Technical Field

The technical field relates to a stereoscopic image processing apparatus for processing a stereoscopic image and a stereoscopic image processing method.

2. Related Art

A stereoscopic image including right and left images (stereoscopic image) having parallax is displayed by a stereoscopic display device that enables stereoscopic display.

When parallax between right and left images displayed on a stereoscopic display device is extremely large, it is difficult for a user to stereoscopically view the image. Techniques that can cope with such a problem are disclosed in JP-A-10-221775 and JP-A-2005-73013. With the technique disclosed in JP-A-10-221775, display positions of right and left images are shifted in right and left directions so that parallax between the right and left images is reduced, thereby causing stereoscopic viewing to be easy. With the technique disclosed in JP-A-2005-73013, display sizes of right and left images are reduced so that parallax on an entire screen is reduced, thereby causing stereoscopic viewing to be easy.

In a method for shifting right and left images to right and left to adjust parallax as described in JP-A-10-221775, when both a maximum parallax value in a projecting direction and a maximum parallax value in a retracting direction exceed an acceptable range, a reduction in the maximum parallax value on one direction increases the maximum parallax value in the other direction. That is, stereoscopic viewing cannot be made to be easy.

In a method for reducing a display size of right and left images as described in JP-A-2005-73013, since an entire image is reduced, it causes a subject to be hardly viewed. Further, the reduction in the image reduces the parallax over the entire screen, thereby deteriorating a stereoscopic effect.

### SUMMARY

In view of the above problem, it is an object of the present invention to provide a stereoscopic image processing apparatus and a stereoscopic image processing method that can output an image to be stereoscopically viewed easily without deteriorating the stereoscopic effect even when a parallax value of a stereoscopic image is large.

A stereoscopic image processing apparatus of this aspect includes an image obtaining unit operable to obtain a stereoscopic image including images at least at two view points, a parallax information obtaining unit operable to obtain parallax information about a parallax value for at least one of an upper region including an upper end of the obtained stereoscopic image and a lower region including a lower end, a display method setting unit operable to set a display method of an image on the region for which the parallax information is obtained, based on the parallax information about the region, an image processor operable to process the image of the stereoscopic image on the region for which the parallax information is obtained, based on the set display method, and an image output unit operable to output a new stereoscopic image obtained based on the processed result.

A stereoscopic image processing method of this aspect includes obtaining a stereoscopic image including images at least at two view points, obtaining parallax information about a parallax value of at least one of an upper region including an upper end of the obtained stereoscopic image and a lower region including a lower end, setting a display method of an image on a region for which the parallax information is obtained based on the parallax information about the region, processing an image on the region of the stereoscopic image for which the parallax information is obtained, and outputting a new stereoscopic image obtained based on a processed result.

The stereoscopic image processing apparatus or the stereoscopic image processing method of this aspect can partially change the display method at the time of reproducing a stereoscopic image. At this time, the display method can be set based on the parallax information. As a result, for example as to the stereoscopic image, the display method for a processing region for which the parallax information is larger than a predetermined value and a display method for a processing region for which the parallax information is smaller than the predetermined value can be set so as to be different from each other. Therefore, even when the parallax value of a stereoscopic image is large, an image to be stereoscopically viewed easily can be output without deteriorating a stereoscopic effect.

On the lower region of an image, a close object is photographed and a projecting parallax value easily becomes large. On the upper region of an image, a far object is photographed, and a retracting parallax value easily becomes large. In order to cope with this problem, in this aspect, as to at least one of the upper region including an upper end and the lower region including a lower end of a stereoscopic image, the display method of an image on the region is set based on parallax information on this region, and the image is processed. As a result, even an image, for which the parallax value on the upper region or the lower region is large, can be output as a stereoscopic image to be easily viewed without deteriorating a stereoscopic effect.

### BRIEF DESCRIPTION OF DRAWINGS

FIG. 1 is a diagram illustrating a stereoscopic image system including a stereoscopic image processing apparatus 1 according to an embodiment.

FIG. 2 is a diagram illustrating a configuration of a signal processor 103 according to the embodiment.

FIG. 3 is a diagram illustrating part of information described in a header section of a stereoscopic image obtained by a parallax information detector 202 according to the embodiment.

FIG. 4 is a diagram describing a region for which the parallax information detector 202 obtains parallax information according to the embodiment.

FIG. 5 is a diagram describing a configuration for which one region is set on an upper end and a lower end of a display screen, respectively, and parallax information about the regions is obtained according to the embodiment.

FIG. 6 is a diagram describing a configuration for which a plurality of regions are set on the upper end and the lower end of the display screen, respectively, and parallax information about these regions is obtained according to the embodiment.

FIG. 7 is a diagram describing a display method for causing the lower end on the display screen to be hardly viewed according to the embodiment.

FIG. 8 is a diagram describing a display method for overlapping an image that is gradually hardly viewed toward the lower end on the display screen according to the embodiment.

FIG. 9 is a diagram describing a display method for causing the lower end on the display screen to be invisible according to the embodiment.

FIG. 10 is a flowchart describing a specific operation in a display method setting unit 203 according to the embodiment.

### DETAILED DESCRIPTION OF PREFERRED EMBODIMENT

A stereoscopic image processing apparatus according to the embodiment will be described below with reference to the drawings.

### 1-1. Configuration of Stereoscopic Image Processing Apparatus

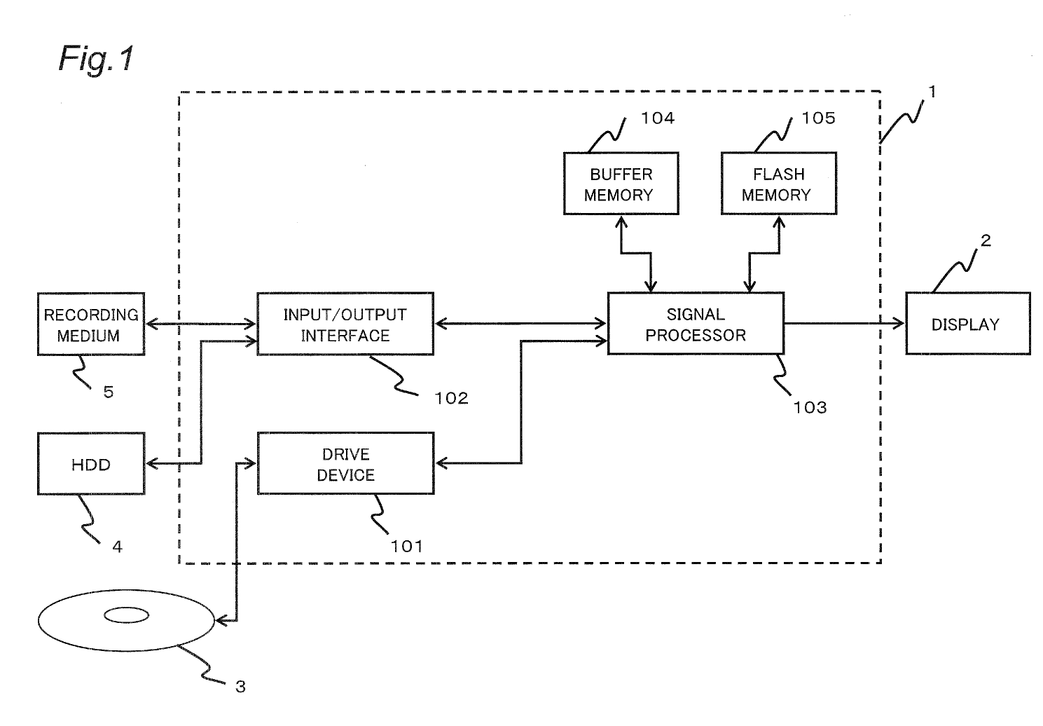

FIG. 1 is a diagram illustrating a configuration of a stereoscopic image system including a stereoscopic image processing apparatus 1.

The stereoscopic image processing apparatus 1 is connected to a display 2, a hard disc device 4 (hereinafter, “HDD 4”), and a recording medium 5. The stereoscopic image processing apparatus 1 inputs an image signal from an optical disc 3, the HDD 4 and the recording medium 5, and processes the input image signal to output it to the display 2. The display 2 displays an image based on the input image signal.

Signals (data) (hereinafter, suitably “stereoscopic image signal”) about a stereoscopic image are recorded in the optical disc 3, the HDD 4, and the recording medium 5. Stereoscopic image signal includes at least a first view point signal and a second view point signal. The first view point signal is an image signal of an image obtained by capturing a subject from a first view point. The second view point signal is an image signal of an image obtained by capturing the subject from a second view point. The first view point and the second view point are set on different positions. The 3D image format may be any image format such as a side-by-side format or a top-and-bottom format. Further, a stereoscopic image may be an image obtained by encoding the first view point signal and the second view point signal according to an MVC standard.

The display 2 can be realized by, for example, a liquid crystal display or a plasma panel display. The display 2 can display a stereoscopic image based on the first view point signal and the second view point signal.

The optical disc 3 stores image signals (image data) of stereoscopic images. The optical disc 3 is, for example, a Btu-ray disc.

The HDD 4 stores image signals (image data) of stereoscopic images.

The recording medium 5 stores image signals (image data) of stereoscopic images. The recording medium 5 can be realized by, for example, a semiconductor recording element such as an SD card or a memory card.

With such a configuration, the stereoscopic image processing apparatus 1 can obtain image signals (image data) of stereoscopic images from the recording media such as the optical disc 3, the HDD 4, and the recording medium 5.

### 1-2. Specific Configuration of Stereoscopic Image Processing Apparatus

A specific configuration of the stereoscopic image processing apparatus 1 will be described with reference to the drawings.

As shown in FIG. 1, the stereoscopic image processing apparatus 1 has a drive device 101, an input/output interface 102 (hereinafter, “input/output IF 102”), a signal processor 103, a buffer memory 104, and a flash memory 105.

The drive device 101 has a disc tray, and the image signals can be read from the optical disc 3 set on the disc tray. The drive device 101 can write the image signal input from the signal processor 103 into the optical disc 3 set on the disc tray.

The input/output IF 102 enables the signal processor 103 to be connected with the HDD 4 and the recording medium 5. The input/output IF 102 enables exchange of a control signal and an image signal with the signal processor 103. The input/output IF 102 transmits stereoscopic image signals input from the HDD 4 and the recording medium 5 to the signal processor 103. The input/output IF 102 transmits the stereoscopic image signal input from the signal processor 103 to the HDD 4 or the recording medium 5. The stereoscopic image signal may be a compressed image signal or an uncompressed image signal. The input/output IF 102 can be connected with external signal receiving apparatuses such as a broadcasting reception tuner and an Internet stream reception apparatus, as well as the HDD 4 and the recording medium 5. The input/output IF 102 can be realized by an HDMI connector, an SD card slot, a USB connector, and the like. In short, the input/output IF 102 may realize an interface between an external recording apparatus (medium) and an external signal receiving apparatus.

The signal processor 103 controls the respective units of the stereoscopic image processing apparatus 1. The signal processor 103 executes decoding and signal processing on stereoscopic image signals output from the input/output IF 102. For example, the signal processor 103 decodes a stereoscopic image signal encoded according to a JPEG encoding standard.

The signal processor 103 obtains information about parallax between a first view point image and a second view point image constituting a stereoscopic image (hereinafter, “parallax information”).

For example, the signal processor 103 calculates a parallax value between the first view point image and the second view point image based on the first view point image and the second view point image, and obtains parallax information based on the calculated parallax value. At this time, the signal processor 103 may use any method such as block matching. The signal processor 103 may obtain parallax information added to a header section of the stereoscopic image signal. When the parallax information is inserted as additional information into the image signal, the signal processor 103 may obtain the parallax information. The signal processor 103 divides the stereoscopic image (the first view point image and the second view point image) into a plurality of regions, and obtains the parallax information of each of the divided regions. The operation for obtaining the parallax information in the signal processor 103 and the regions of which parallax information is obtained will be described later.

Further, the signal processor 103 sets a display method of an image on the region for which the parallax information is obtained based on the obtained parallax information. An operation for setting the display method will be described later.

The signal processor 103 may be configured by a microcomputer or a hard-wired circuit.

The buffer memory 104 is used as a work memory when the signal processor 103 executes the signal process. The buffer memory 104 can be realized by, for example, DRAM.

The flash memory 105 stores programs or the like to be executed by the signal processor 103.

### 1-3. Specific Configuration of Signal Processor

A specific operation of the signal processor 103 will be described.

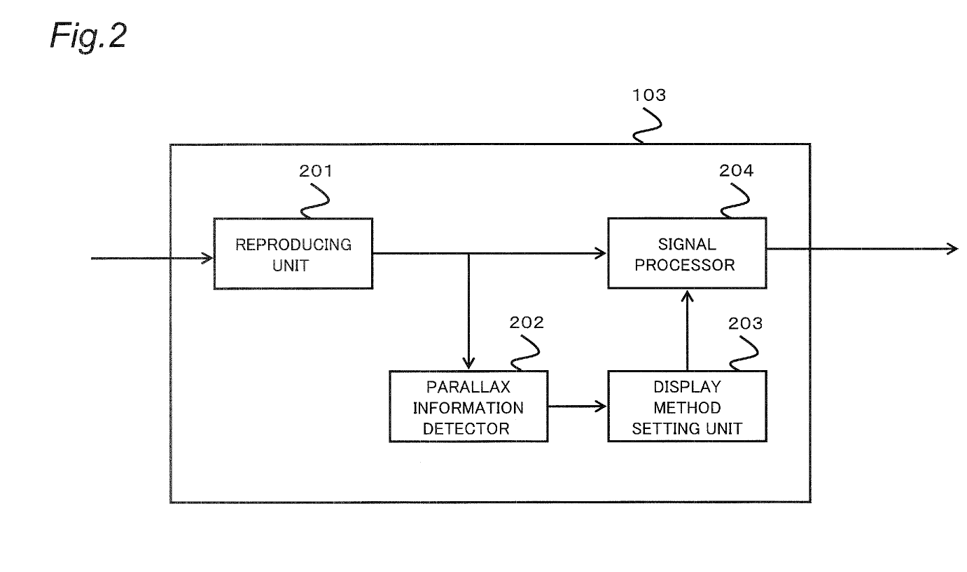

FIG. 2 is a diagram illustrating the configuration of the signal processor 103.

The signal processor 103 has an image reproducing unit 201, a parallax information detector 202, a display method setting unit 203, and a signal processor 204.

The image reproducing unit 201 decodes a stereoscopic image signal obtained by the drive device 101 or the input/output IF 102. The image reproducing unit 201 outputs the decoded stereoscopic image signal to the parallax information detector 202 and the signal processor 204.

The parallax information detector 202 obtains the parallax information of the stereoscopic image on each of predetermined regions based on the stereoscopic image signal input from the image reproducing unit 201. In a case that the stereoscopic image is, for example, divided into a plurality of regions, the predetermined regions correspond to each of divided regions. The parallax information detector 202 may obtain the parallax information on each of the predetermined regions based on information about a stereoscopic effect described in the header section of the stereoscopic image signal.

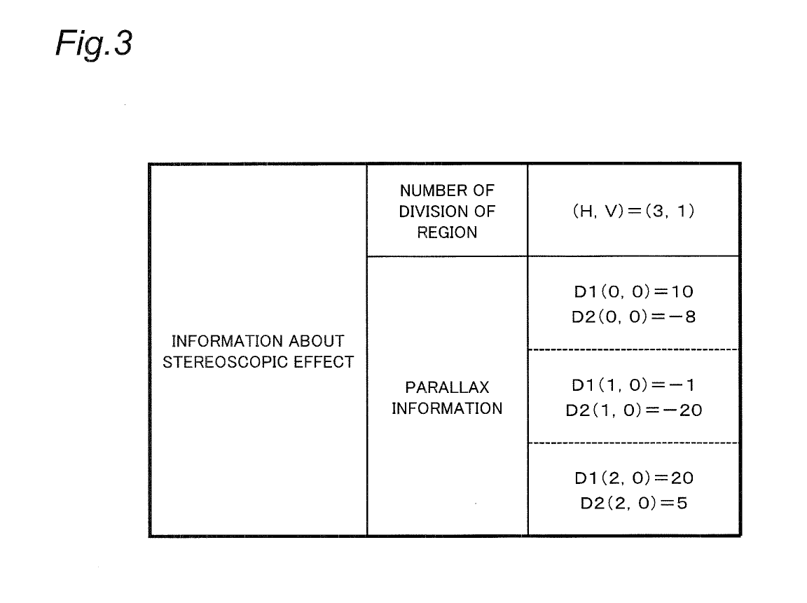

FIG. 3 is a diagram illustrating part of the information about the stereoscopic effect described in the header section of the stereoscopic image signal.

As the information about the stereoscopic effect, the number of division to the region and the parallax information on each of the regions are described in the header section of the stereoscopic image signal. The parallax information detector 202 obtains the number of division to the region and the parallax information.

The number of division to the region represents the number of regions in a horizontal direction and the number of regions in a vertical direction on the stereoscopic image. In FIG. 3, (H,V) represents the number of regions in the horizontal direction and the number of regions in the vertical direction. For example, when (H,V)=(3,1), this represents that the stereoscopic image is divided into three in the horizontal direction and is divided into one (is not divided) in the vertical direction. In this case, the stereoscopic image has three regions.

The parallax information is parallax information in each of the regions after division. D1 and D2 shown in FIG. 3 represents a maximum projecting parallax value and a maximum retraction parallax value on one region. Moreover, (0,0), (1,0) and (2,0) are values indicating regions in the plurality of divided regions, respectively. For example, (0,0) indicates a region in the 0th row and 0th column. Further, (1,0) indicates a region in the 1st row and 0th column. FIG. 3 illustrates a case where two parallax values of D1 and D2 are included as the parallax information about the respective regions.

The parallax information detector 202 may obtain the parallax information about each of the regions according to the following operation. That is, the parallax information detector 202 divides the stereoscopic image represented by the stereoscopic image signal input from the image reproducing unit 201 into a plurality of regions, and calculates a plurality of parallax values for the divided regions, respectively. The parallax information detector 202 sets the parallax value representing each of the regions as the parallax information based on the calculated parallax values. The parallax information detector 202 may set at least one of a maximum projecting parallax value and a maximum retraction parallax value in the plurality of parallax values calculated on each of the regions as the representative parallax value on each of the region. Further, the parallax information detector 202 may set an average value or a central value of the plurality of parallax values calculated on each of the regions as the parallax value representing each of the regions.

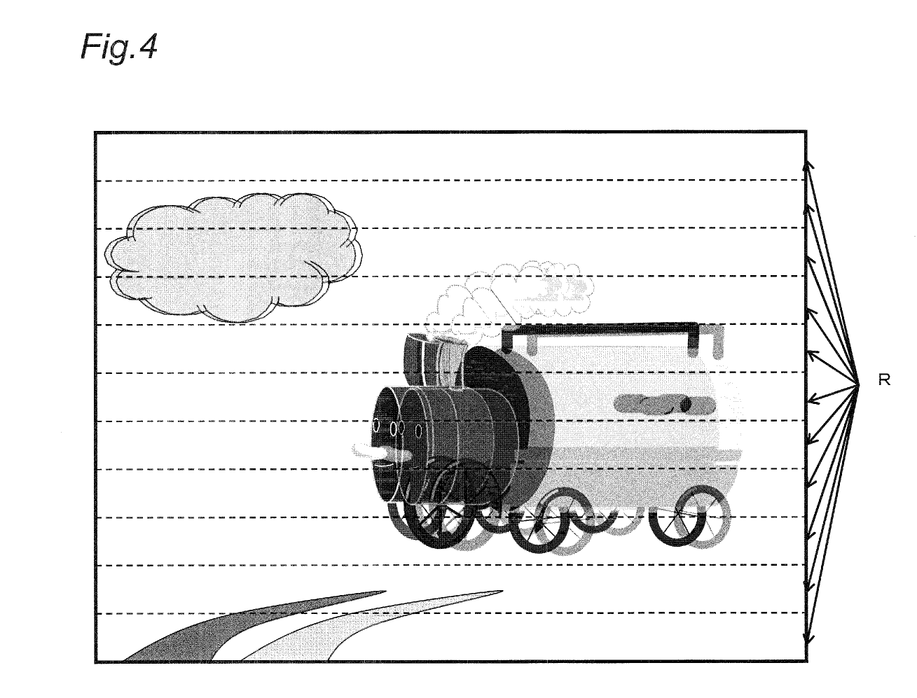

FIG. 4 to FIG. 6 are diagrams describing regions for which the parallax information detector 202 obtains the parallax information.

In an example shown in FIG. 4, the parallax information detector 202 divides the stereoscopic image into a plurality of regions R in the vertical direction. The parallax information detector 202 obtains the parallax information on the respective regions obtained by division. An image size in the horizontal direction of each of the divided regions is the same as an image size of the stereoscopic image in the horizontal direction.

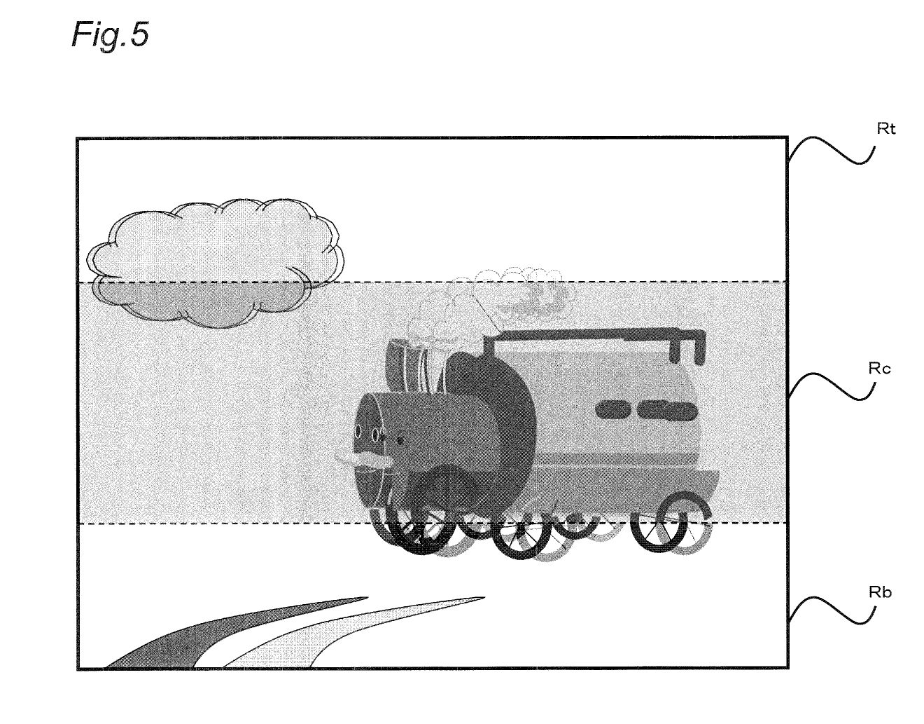

In an example shown in FIG. 5, when obtaining parallax information, the parallax information detector 202 obtains parallax information about an upper end region (a predetermined region including an upper end) Rt and a lower end region (a predetermined region including a lower end) Rb in the stereoscopic image. A region (shaded region) Rc between the upper end region Rt and the lower end region Rb is a region for which parallax information is not obtained.

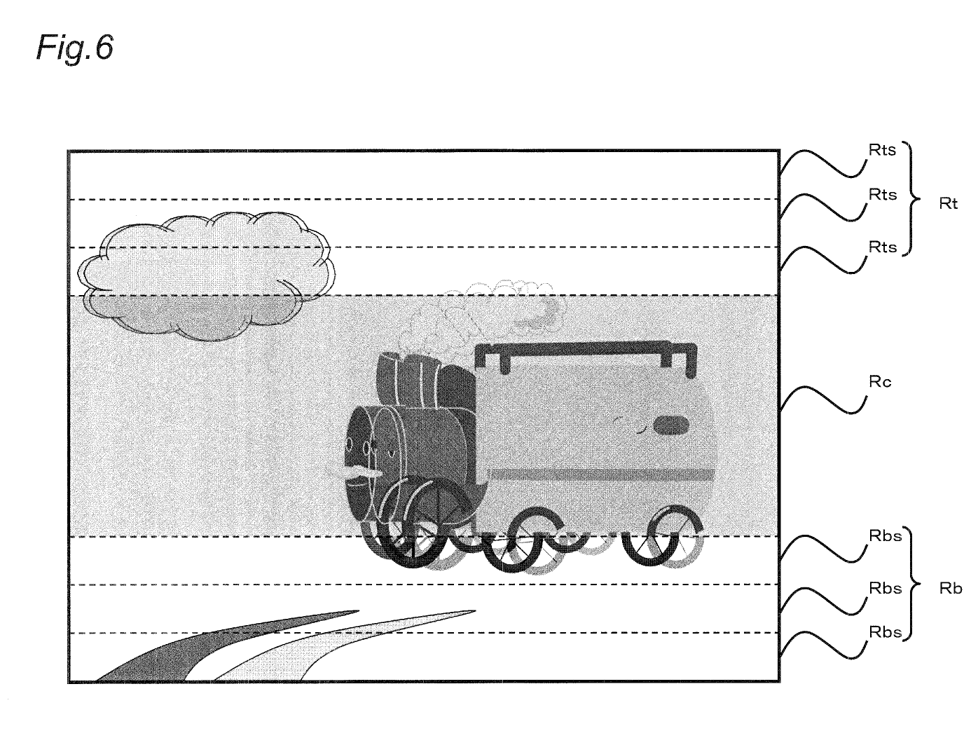

In an example shown FIG. 6, the parallax information detector 202 divides the upper end region Rt into a plurality of small regions Rts, and divides the lower end region Rb into a plurality of small regions Rbs so as to obtain parallax information about the respective divided regions Rts and Rbs.

In FIG. 4 to FIG. 6, the case is described in which the image size in the horizontal direction on each of the regions for which the parallax information is obtained is the same as an image size of the stereoscopic image in the horizontal direction. However, the image size in the horizontal direction on each of the regions for which the parallax information is obtained may be different from the image size in the horizontal direction of the stereoscopic image. The example is described in which the division is performed in the vertical direction, but the division may be performed in the horizontal direction. In this case, the image size in the vertical direction on each of the regions for which the parallax information is obtained may be the same as or different from the image size in the vertical direction of the stereoscopic image.

The parallax information detector 202 outputs the obtained parallax information to the display method setting unit 203. At this time, the parallax information detector 202 preferably outputs, to the display method setting unit 203, the parallax information for which each of the divided regions on the stereoscopic image is related with the parallax information obtained on each of the divided regions.

The display method setting unit 203 sets display methods for the images on the respective divided regions based on the parallax information about the respective divided regions input from the parallax information detector 202, and relates the set display methods with the respective divided regions so as to output them to the signal processor 204.

The signal processor 204 processes stereoscopic image signals (image data) of the respective divided regions according to the display methods set by the display method setting unit 203. The signal processor 204 outputs new stereoscopic image signals generated by the process to the display 2.

### 1-4. Example of Display Method Set by the Display Method Setting Unit

An example of the display method set by the display method setting unit 203 will be described.

The display method setting unit 203 sets any one of the following three display methods for each of the divided regions based on the parallax information input from the parallax information detector 202:

a display method 1: the display method for displaying the image on each of the regions as it is;

a display method 2: the display method for causing the image on each of the regions to be hardly viewed or be invisible; and

a display method 3: the display method for displaying the image on each of the regions after adjusting parallax.

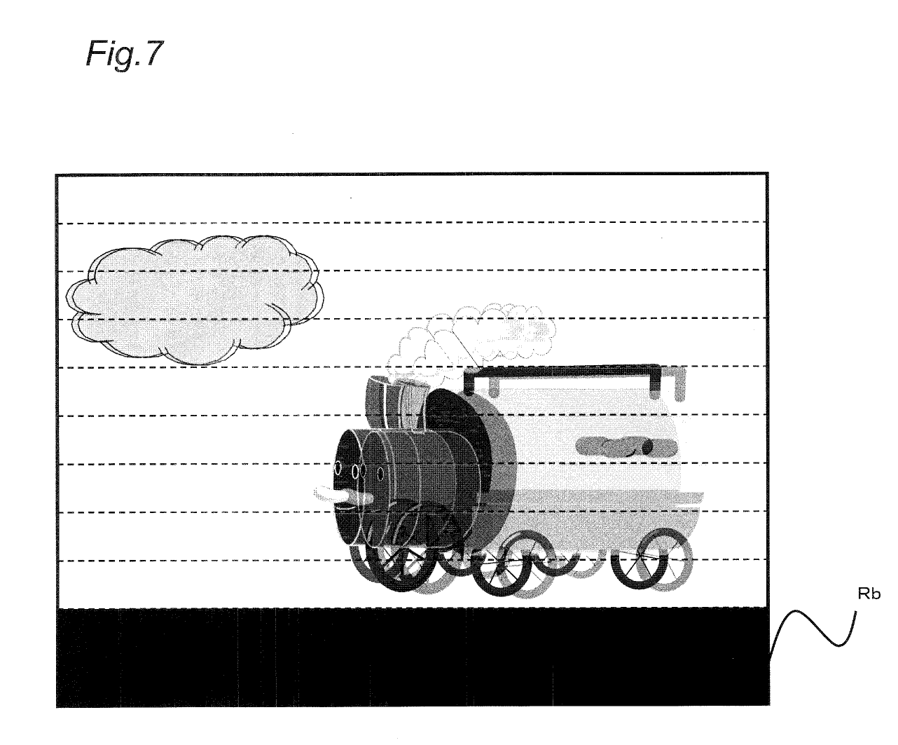

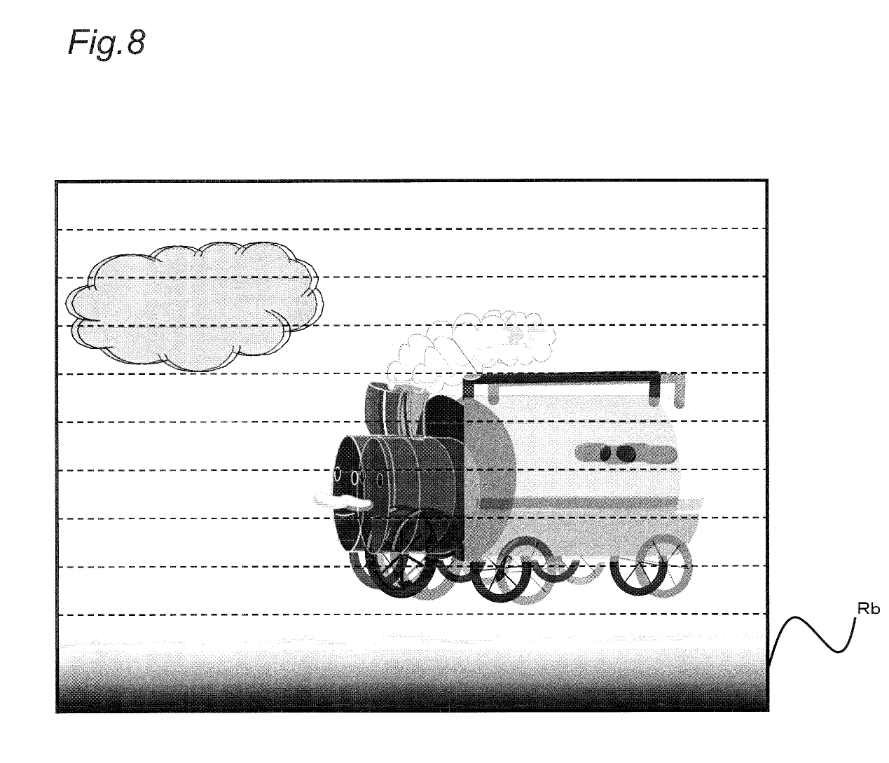

An example of the display method 2 for causing the image to be hardly viewed is a method for overlapping a predetermined image with an image on a region and displaying the image so as to cause the image on the region to be hardly viewed. FIG. 7 and FIG. 8 are diagrams describing the examples of the method.

In an example shown in FIG. 7, the display method setting unit 203 overlaps a black image on the lower end region Rb of the stereoscopic image so as to cause the image on the region Rb to be hardly viewed. The image to be overlapped and displayed may not be a black image but may be a single-color image such as a white image.

In an example shown in FIG. 8, the display method setting unit 203 overlaps a gradation image for which a black color becomes gradually denser toward the lower end region Rb of the stereoscopic image and displays the image so as to cause the image on the region Rb to be hardly viewed. In the example shown in FIG. 8, a transparent gradation image is overlapped, but the image to be overlapped is not limited thereto. For example, the original image on the lower end region Rb may be subjected to a gradation process so that the black color becomes denser (darker) toward the lower end and the image on the region Rb is made to be hardly viewed.

Although not illustrated, the display method setting unit 203 may overlap an image of which drawing pattern is completely different on the lower end region of the stereoscopic image instead of the single-color image in FIG. 7 or the gradation image in FIG. 8 and display the image so as to cause the image on the region to be hardly viewed.

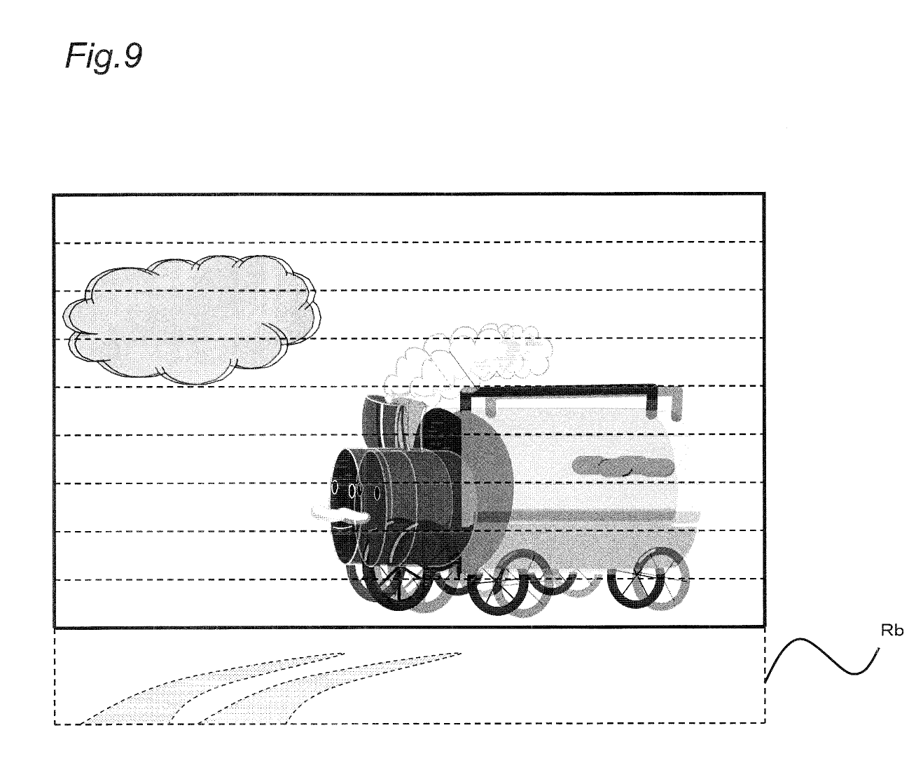

An example of the display method 2 for causing the image to be invisible is a method for deleting image data of the image on the region so as to cause the image on the region to be hardly viewed. FIG. 9 is a diagram describing an example of the method.

In an example shown in FIG. 9, the display method setting unit 203 deletes the image on the lower end region Rb on the stereoscopic image so as to cause the image on the region to be invisible.

In the examples of FIG. 7 to FIG. 9, the case where the lower end region Rb is caused to be hardly viewed or be invisible is described, but the same idea can be applied also to the case of the upper end region. When a gradation image is overlapped on the upper end, a gradation image of which black color becomes gradually denser toward the upper end may be overlapped to be displayed.

### 1-5. Specific Example of the Operation in the Display Method Setting Unit

The specific operation of the display method setting unit 203 will be described.

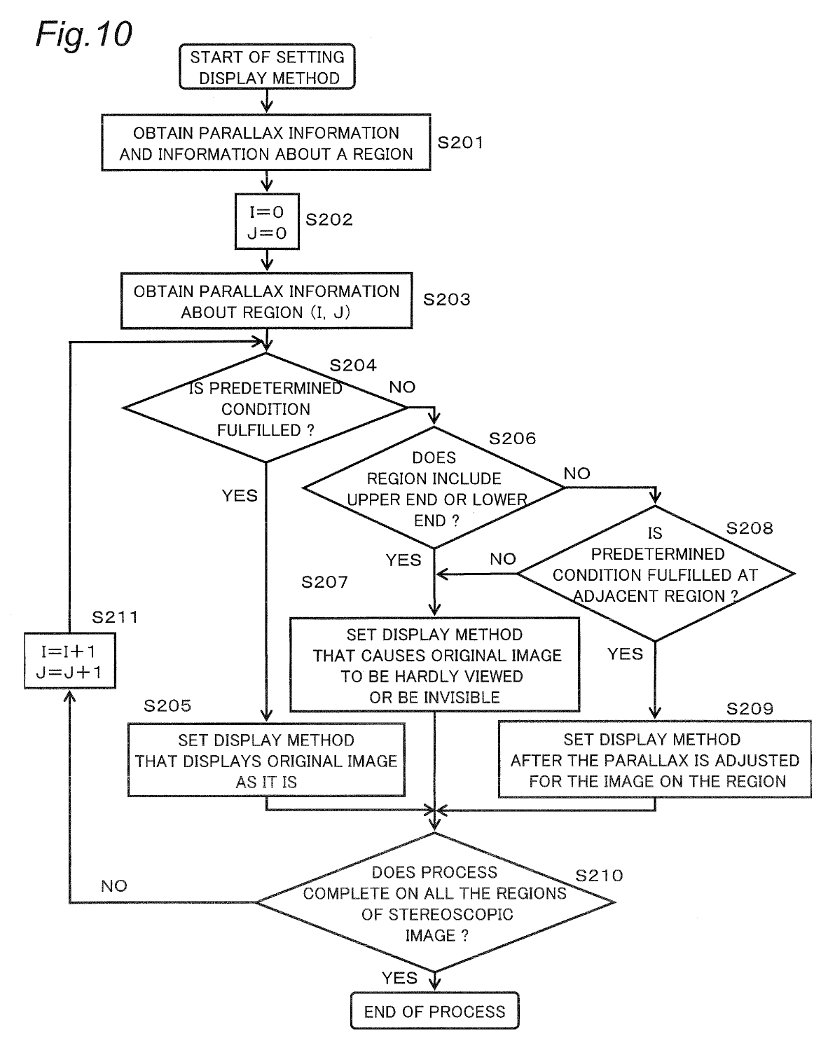

FIG. 10 is a flowchart describing the specific operation of the display method setting unit 203.

The display method setting unit 203 obtains parallax information and information about a region (S201).

The display method setting unit 203 initializes a region to be processed (S202).

The display method setting unit 203 obtains parallax information about the region to be currently processed (S203).

The display method setting unit 203 determines whether the obtained parallax information fulfills a predetermined condition (S204). The predetermined condition may be set based on a safety parallax condition defined by, for example, 3D consortium or the like or may be set arbitrarily. For example, when the parallax values D1 and D2 are calculated as the parallax information on each region, a determination is made whether D1 and D2 are smaller than a predetermined value. The predetermined value is a value indicating parallax providing difficulty in stereoscopic viewing, and can be set arbitrarily by a designer or a user. Specifically, the predetermined value may be set so that the parallax between a parallactic angle of a portion viewed as being projected the most and a parallactic angle of a portion viewed as being retracted the most is ±1 degrees. The value ±1 degrees is one example.

The display method setting unit 203 may determine whether the parallax information fulfills the predetermined condition for the upper end of the stereoscopic, image using only D2. Further, the display method setting unit 203 may determine whether the parallax information fulfills the predetermined condition for the lower end of the stereoscopic image, using only D1. When the parallax information on the region to be processed fulfills the predetermined condition, the display method setting unit 203 sets the display method 1 on the region to be processed (S205). That is, the display method setting unit 203 sets the display method for displaying the image on the region as it is. The display method setting unit 203 outputs a control signal representing that the display method 1 is set on the region to the signal processor 204.

On the other hand, when the parallax information on the region to be processed does not fulfill the predetermined condition, the display method setting unit 203 determines whether the region to be processed includes the upper end or the lower end of the stereoscopic image (S206). When the region to be processed includes the upper end or the lower end of the stereoscopic image, the display method setting unit 203 sets the display method 2 on the region to be processed (S207). That is, the display method setting unit 203 sets the display method that causes the image on the region to be hardly viewed or be invisible. The display method setting unit 203 outputs a control signal representing that the display method 2 is set on the region to the signal processor 204.

On the contrary, when the region to be processed does not include the region including the upper end nor the region including the lower end of the stereoscopic image, the display method setting unit 203 determines whether a region adjacent to the region to be processed fulfills the predetermined condition (S208). When the determination is made that the region fulfills the predetermined condition, the display method setting unit 203 sets the method 3 on the region to be processed (S209). That is, after the parallax is adjusted for the image on the region, the display method setting unit 203 sets the display method. The display method setting unit 203 outputs a control signal representing that the method 3 is set on the region to the signal processor 204.

On the other hand, when the determination is made that the region does not fulfill the predetermined condition, the display method setting unit 203 proceeds to step S207.

The display method setting unit 203 determines whether the process on all the regions of the stereoscopic image is completed (S210). When the process on all the regions is completed, the process in this flowchart is ended. On the other hand, when the process on all the regions is not completed, the display method setting unit 203 sets a next region as the region to be processed (S211), and the process goes to step S204.

### 1-6. Conclusion

The stereoscopic image processing apparatus 1 according to the embodiment includes the input/output IF 102, the parallax information detector 202, the display method setting unit 203, and the signal processor 204. The input/output IF 102 obtains the stereoscopic image including images at least at two view points. The parallax information detector 202 obtains the parallax information about the parallax value for at least one of the upper region including the upper end and the lower region including the lower end of the obtained stereoscopic image. The display method setting unit 203 sets the display method of the image on the region for which the parallax information is obtained based on the parallax information on the region. The signal processor 204 processes the image on the region of the stereoscopic image for which the parallax information is obtained based on the set display method, and outputs a new stereoscopic image obtained based on the processed result.

With the above configuration, when the stereoscopic image is reproduced, the display method can be partially changed. Further, the display method can be set based on the parallax information. As a result, on the stereoscopic image, the display method for the region for which the parallax information is larger than a predetermined value can be set to be different from the display method for the processing region for which the parallax information is smaller than the predetermined value. Therefore, even when the parallax value of the stereoscopic image is large, an image to be stereoscopically viewed easily can be output without deteriorating the stereoscopic effect.

A close object is photographed particularly on the lower region of the image, and the projecting parallax value easily increases. A far object is photographed on the upper region of the image, and the retraction parallax value easily increases. In order to cope with this problem, in this embodiment, the display method is set for the image on the region for at least one of the upper region including the upper end and the lower region including the lower end of the stereoscopic image based on the parallax information about the region, and the image is processed. As a result, even the image for which the parallax value of the upper region or the lower region is large can be output as the stereoscopic image to be easily viewed without deteriorating the stereoscopic effect.

The display method setting unit 203 sets the display method that causes the image on the region to be hardly viewed for the region for which the parallax value represented by the obtained parallax information is larger than a predetermined value.

With such a configuration, for example, when the region for which the parallax value represented by the parallax information is larger than the predetermined value is displayed, the image on the region can be caused to be hardly viewed. As a result, attention of a user who views the stereoscopic image is distracted from the image on the region, and the user does not view the image on the region directly. For this reason, the difficulty in the stereoscopic viewing of the stereoscopic image of which parallax value is large can be lessened.

Further, the signal processor 204 executes a process for overlapping to display a predetermined image on the image on the region for which the display method for causing the image to be hardly viewed is set by the display method setting unit 203.

In this case, when the region for which the parallax information is obtained is the upper region, the predetermined image is an image being subjected to the gradation process for causing the image on the upper region to be more hardly viewed toward the upper end of the stereoscopic image. When the region for which the parallax information is obtained is the lower region, the predetermined image is an image being subjected to the gradation process for causing the image on the lower region to be more hardly viewed toward the lower end of the stereoscopic image.

With the above configuration, for example, when the region for which the parallax value represented by the parallax information is larger than the predetermined value is displayed, the image on the region can be caused to be more hardly viewed toward the upper end or the lower end of the stereoscopic image. As a result, attention of a user who views the stereoscopic image is distracted from the image on the region, and the user does not view the image on the region directly. Since the gradation process is given to the image of the stereoscopic image on the upper region or the lower region so that the image becomes to be hardly viewed toward the upper end or the lower end, user's uncomfortable feeling can be reduced, and the difficulty in the stereoscopic viewing at the time of viewing the stereoscopic image can be further lessened.

Further, when the parallax value represented by the obtained parallax information is larger than a predetermined value, the display method setting unit 203 sets the display method that causes the image on the region for which the parallax value is larger than the predetermined value to be invisible.

With the above configuration, for example, when the region for which the parallax information is larger than the predetermined value is displayed, the image on the region can be caused to be invisible. As a result, since the image on the region can be prevented from being directly viewed, the difficulty in the stereoscopic viewing at the time of viewing the stereoscopic image with a large parallax value can be lessened.

The signal processor 204 executes a process for deleting the image on the region for which the display method setting unit 203 has set the display method that causes the image to be invisible.

At this time, a size of the region in the horizontal direction is the same as the image size of the stereoscopic image in the horizontal direction.

With the above configuration, for example, in a general scene/landscape, by utilizing a tendency that the upper end is far and the lower end is close, the upper end and the lower end for which the parallax is likely to be large can be easily cut out.

In this embodiment, the upper region and the lower region of the obtained image include a plurality of regions, respectively, and the image size in the horizontal direction on the region for which the parallax information detector 202 obtains parallax information is equal to the image size of the stereoscopic image in the horizontal direction. The parallax information detector 202 obtains the parallax information about the parallax value on the plurality of regions on at least one of the upper region and the lower region. As for the upper region, the display method setting unit 203 determines whether the parallax values on the respective regions are larger than the predetermined value sequentially starting from the upper end region. When the parallax value on the determined region is larger than the predetermined value, the display method that causes the image on the region to be hardly viewed or the display method that causes the image on the region to be invisible is set for the region. The display method setting unit 203 continues to determine whether the parallax value on a region lower-adjacent to the region is larger than the predetermined value. When the parallax value on the region is not larger than the predetermined value, the display method setting unit 203 does not set the display method that causes the image on the region to be hardly viewed nor the display method that causes the image on the region to be invisible, and ends the determination on the regions lower than that region. On the contrary, as for the lower region, the display method setting unit 203 determines whether the parallax values on the respective regions are larger than the predetermined value sequentially starting from the lower end region. When the parallax value on the determined region is larger than the predetermined value, the display method setting unit 203 sets the display method that causes the image on the region to be hardly viewed or the display method that causes the image on the region to be invisible, and continues to determine whether the parallax value on a region upper-adjacent to the region is larger than the predetermined value. When the parallax value on this adjacent region is not larger than the predetermined value, the display method setting unit 203 does not set the display method that causes the image on the region to be hardly viewed nor the display method that causes the image on the region to be invisible, and ends the determination on the regions above that region.

With such a configuration, at least one of the upper region and the lower region of the stereoscopic image is divided into a plurality of regions so that the parallax information can be obtained. Further, the size of the region for which the parallax information is obtained can be matched with the image size of the stereoscopic image in the horizontal direction. The determination can be made whether the parallax value is larger than the predetermined value on each region for which the parallax information is obtained. Further, the processing region can be set based on the determined result. As a result, even when a lower portion of an image has the large projecting parallax information because a close object is photographed and an upper portion of the image has the large retraction parallax because a far object is photographed, such an image can be output as the stereoscopic image to be easily viewed without deteriorating the stereoscopic effect. Further, for example, the display method can be changed for a truly necessary portion on the lower portion of the image or the upper portion of the image.

### 2. Other Embodiments

The embodiment has mainly described the process for still images. However, the process can also be applied to moving images.

In a digital camera described in the embodiment, respective functional blocks (respective units) shown in FIG. 1 and FIG. 2 may be individually formed into respective chips by a semiconductor apparatus such as LSI, or may be formed as one chip including some or all of the functional blocks.

Here, the semiconductor apparatus is LSI, but may be also referred to as IC, system LSI, super LSI, or ultra LSI according to a difference in an integration degree.

The integrated circuit is not limited to LSI, but may be realized by a special-purpose circuit or a general-purpose processor. Further, after manufacturing of LSI, the integrated circuit can be realized by FPGA (Field Programmable Gate Array) or reconfigurable processor that can reconfigure connection or setting of circuit cells in LSI.

If any technology of the integrated circuit that replaces LSI comes out due to deployment of semiconductor technology and a derivative technology, the respective functional blocks may be integrated by that technology. Biotechnology might be applied to the integration.

The respective processes in the above embodiment may be realized by hardware or software. Further, the processes may be realized by a mixed process of software and hardware. When the digital camera according to the embodiment is realized by hardware, timing adjustment is necessary for executing the respective processes. In the above embodiment, for convenience of the description, details of the timing adjustment of various signals caused by actual hardware design are omitted.

The executing order of the processing methods in the above embodiment is not necessarily limited to the order described in the embodiment, and the order can be changed within a scope that does not deviate from the gist of the idea described in the embodiment.

The specific configuration is not limited to the above embodiment, and can be variously changed and modified within the scope that does not deviate from the gist of the idea described in the embodiment.

### INDUSTRIAL APPLICABILITY

According to the 3D image signal processing apparatus and the 3D image processing method in the embodiment, even when the parallax value of a stereoscopic image is large, an image that is stereoscopically viewed easily can be output without deteriorating the stereoscopic effect. For this reason, the apparatus and the method can be applied also to a digital camera for photographing a 3D image, a broadcasting camera, and a recorder or player for recording and reproducing a 3D image.

What is claimed is:

1. A stereoscopic image processing apparatus, comprising:
an image obtaining unit operable to obtain a stereoscopic image including images at least at two view points;
a parallax information obtaining unit operable to obtain parallax information about a parallax value for at least one of an upper region including an upper end and a lower region including a lower end of the obtained stereoscopic image;
a display method setting unit operable to set a display method of an image on the region for which the parallax information is obtained, based on the parallax information about the region;
an image processor operable to process the image of the stereoscopic image on the region for which the parallax information is obtained, based on the set display method; and
an image output unit operable to output a new stereoscopic image obtained based on the processed result.

2. The stereoscopic image processing apparatus according to claim 1, wherein when the parallax value represented by the obtained parallax information is larger than a predetermined value, the display method setting unit sets a display method that causes the image on the region for which the parallax value is larger than the predetermined value to be hardly viewed.

3. The stereoscopic image processing apparatus according to claim 2, wherein the image processor executes a process for overlapping a predetermined image on the image on the region and displaying the overlapped image on the region for which the display method setting unit sets the display method that causes the image to be hardly viewed.

4. The stereoscopic image processing apparatus according to claim 3, wherein when the region for which the parallax information is obtained is the upper region, the predetermined image is an image subjected to a gradation process for causing the image on the upper region to be more hardly viewed toward the upper end of the stereoscopic image, and when the region for which the parallax information is obtained is the lower region, the predetermined image is an image subjected to a gradation process for causing the image on the lower region to be more hardly viewed toward the lower end of the stereoscopic image.

5. The stereoscopic image processing apparatus according to claim 1, wherein when the parallax value represented by the obtained parallax information is larger than the predetermined value, the display method setting unit sets a display method that causes the image on the region for which the parallax value is larger than the predetermined value to be invisible.

6. The stereoscopic image processing apparatus according to claim 5, wherein the image processor executes a process for deleting an image on the region for which the display method setting unit sets the display method for causing the image to be invisible.

7. The stereoscopic image processing apparatus according to claim 1, wherein an image size in a horizontal direction on the region for which the parallax information is obtained is equal to an image size of the stereoscopic image in the horizontal direction.

8. The stereoscopic image processing apparatus according to claim 1, wherein
the upper region and the lower region include a plurality of regions, respectively,
an image size in a horizontal direction on the region for which the parallax information obtaining unit obtains the parallax information is equal to an image size of the stereoscopic image in the horizontal direction,
the parallax information obtaining unit obtains parallax information about the parallax value on each of a plurality of regions included in at least one of the upper region and the lower region,
as for the upper region,
the display method setting unit determines whether the parallax value on each of the regions of the upper region is larger than a predetermined value sequentially starting from an upper end region,
and when the parallax value on the determined region is larger than the predetermined value, the display method setting unit sets a display method for causing the image on the region to be hardly viewed or a display method for causing the image on the region to be invisible, and continues to determine whether a parallax value of a region lower-adjacent to the region is larger than the predetermined value,
and when the parallax value on the lower-adjacent region is not larger than the predetermined value, the display method setting unit does not set the display method for causing the image on the region to be hardly viewed nor the display method for causing the image on the region to be invisible and ends the determination on the regions below the region,
as for the lower region,
the display method setting unit determines whether the parallax value on each of the regions of the lower region is larger than the predetermined value sequentially starting from the lower end region,
and when the parallax value on the determined region is larger than the predetermined value, the display method setting unit sets the display method for causing the image on the region to be hardly viewed or the display method for causing the image on the region to be invisible, and the display method setting unit continues to determine whether the parallax value on a region upper-adjacent to the region is larger than the predetermined value,
and when the parallax value on the upper-adjacent region is not larger than the predetermined value, the display method setting unit does not set the display method for causing the image on the region to be hardly viewed nor the display method for causing the image on the region to be invisible and ends the determination on the regions above the region.

9. A stereoscopic image processing method, comprising:
obtaining a stereoscopic image including images at least at two view points;
obtaining parallax information about a parallax value for at least one of an upper region including an upper end of the obtained stereoscopic image and a lower region including a lower end;
setting a display method for an image on the region for which the parallax information is obtained based on the parallax information about the region;
processing the image of the stereoscopic image on the region for which the parallax information is obtained based on the set display method; and
outputting a new stereoscopic image based on the processed result.
